(19) United States
(12) Patent Application Publication
(10) Pub. No.: US 2007/0176321 A1
(43) Pub. Date: Aug. 2, 2007

(54) Flexible mold for flat display panel and method of manufacturing the same

(76) Inventors: Sang Jin Oh, Seoul City (KR); Seung Mok Oh, Seoul City (KR); Joon Kyu Park, Osan City (KR); Hye Jin Lee, Seoul City (KR); Ji Hyun Kim, Suwon City (KR); Soon Kook Hong, Seongnam City (KR); Young Sun You, Gumi City (KR)

Correspondence Address: KED & ASSOCIATES, LLP, P.O. Box 221200, Chantilly, VA, 20153-1200, US

(21) Appl. No.: 11/647,553

(22) Filed: Dec. 29, 2006

(30) Foreign Application Priority Data
Dec. 29, 2005 (KR) 2005-0133882

(51) Int. Cl. B29C 33/40; B29C 43/02; B29C 43/32; B29C 41/46; B27N 3/18; B28B 3/00; B28B 3/02; B29C 51/00

(52) U.S. Cl. 264/219; 264/319

(57) ABSTRACT

A method of fabricating a flexible mold for forming a flat display panel, comprising: forming a plurality of protrusions on a flexible film, forming plated patterns between the protrusions on the flexible film, the plated patterns having an inverted shape corresponding to partitions that define one or more sub-pixel regions in the panel, and removing the protrusions to form a flexible material.

### BACKGROUND

1. Field

One or more embodiments described herein relate to a display device.

2. Background

Flat panel displays have become very popular because of their large screen and thin width. Presently, a variety of flat panel displays are available including liquid crystal displays (LCDs), plasma display panels (PDPs), and organic electro-luminescent displays (OLEDs) to name a few.

In spite of their widespread appeal, PDPs have inconsistencies caused by manufacturing defects. These inconsistencies result in poor light emission and therefore are considered highly undesirable. Example of inconsistencies that result during manufacture include cracks in the glass forming bottom or top surfaces of the panel and unevenly formed partitions that define the pixels/sub-pixels of the display. Inconsistencies also result from defects in the equipment used during the manufacturing process.

### BRIEF DESCRIPTION OF THE DRAWINGS

The embodiments will be described in detail with reference to the following drawings in which like reference numerals refer to like elements wherein:

FIG. 1 is diagram showing one type of flat display panel;

FIGS. 2a-2c are cross-sectional diagrams showing steps included in a process which uses a metallic mold to form partitions in a flat display panel;

FIGS. 3a-3c are cross-sectional diagrams showing steps included in a process which uses a flexible mold to form partitions in a flat display panel;

FIGS. 4a-4d are cross-sectional diagrams showing steps included in a method for fabricating a mold to be used in molding partitions in a flat display panel; and

FIGS. 5a-5e are cross-sectional diagrams showing steps included in a method of molding partitions in a flat display panel using, for example, the mold formed by FIGS. 4a-4d.

### DETAILED DESCRIPTION

A plasma display panel displays an image by allowing one or more inert gases, such as neon (Ne), helium (He), Xe (Xenon), etc., to be discharged between two opposing panels. Ultra-violet rays are then generated to produce a discharge, as a result of the rays exciting phosphors disposed in cells defining the pixel/sub-pixels of the panel.

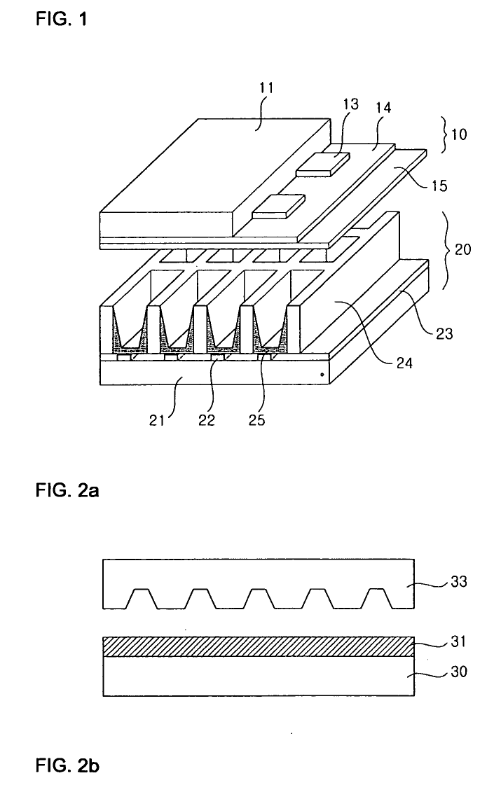

FIG. 1 shows one type of plasma display panel which includes a top panel 10 and a bottom panel 20. The top panel and the bottom panel are adhesively bonded to each other to form a top surface and bottom surface of the plasma display panel.

The top panel includes a top glass 11 with bus electrodes 13 formed on a bottom surface thereof. The bottom surface is also formed to include a dielectric layer 14 in beta form. The dielectric layer is protected by a protection film 15. That is, the protection film is coated on the entire surface of the dielectric layer. The protection film may be formed from magnesium oxide (MgO). The protection film also serves as a source of secondary electrons.

The bottom panel includes a bottom glass 21 where address electrodes 22 are formed on a top surface thereof. The top surface is formed with a dielectric layer 23, on which a plurality of linear partitions 24 are formed at predetermined intervals. The partitions cross each other at right angles in lengthwise and crosswise directions to form a structure often referred to as a closed-type structure. In this arrangement, the partitions are formed as stripes, e.g., the partitions form linearly defined spaces in a longitudinal direction. The top surface of dielectric layer 23 is also coated with phosphors 25 at areas defined by the partitions. Phosphors 25 may alternately be classified by red (R), green (G), and blue (B) sub-pixel colors.

The top panel 10 and bottom panel 20 are bonded to each other with a predetermined gap between them, with one or more discharge (e.g., inert) gases encapsulated between them. With the plasma display panel configured in this manner, phosphors 25 (coated within the discharge spaces defined by partitions 24) are excited by ultra-violet rays to thereby emit visible rays through the top panel of the display corresponding to an image.

Partitions 24 may be formed on the bottom panel through an etching process or molding process. The molding process may be performed using either a metallic mold or flexible mold.

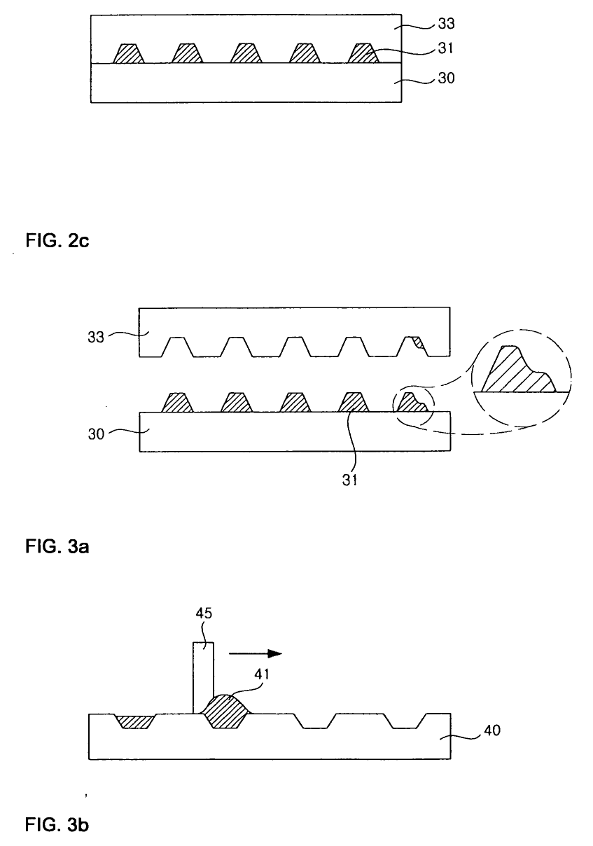

FIGS. 2a-2c show steps included in a process which uses a metallic mold to form the partitions (e.g., pixel or sub-pixel walls) in a plasma display panel. According to this process, a partition source material 31 is coated on a top surface of bottom glass 30 with a uniform thickness. A metallic mold 33, formed with inverted-partition shapes, is then positioned above and in alignment with the top surface of the bottom glass. The metallic mold is then pressed downwardly with a predetermined amount of pressure to perform press molding. When the partition source material 31 is pressed, a curing step is performed. When curing is completed, the metallic mold and bottom glass are separated from each other. The bottom glass is then molded with partitions as shown in FIG. 2c.

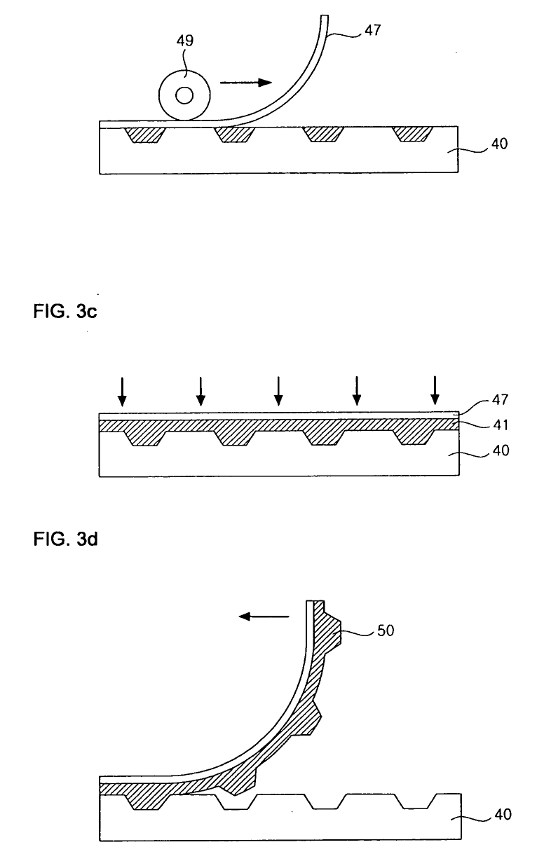

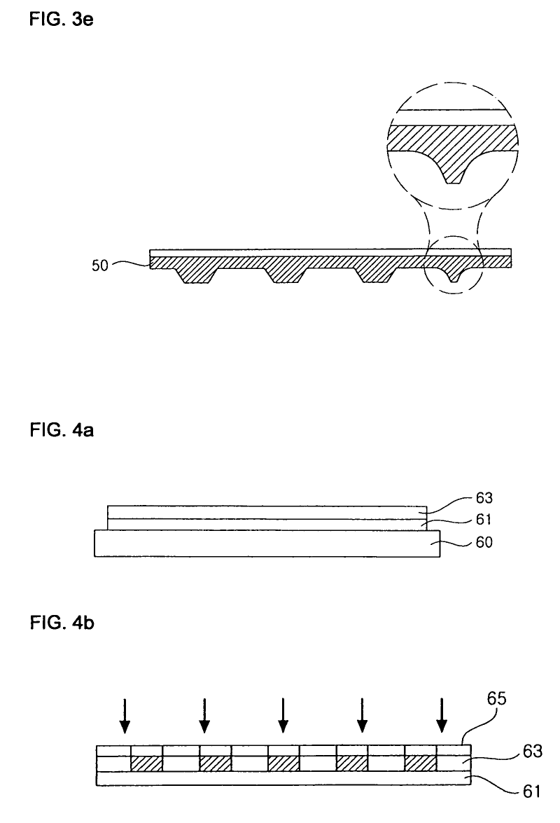

FIGS. 3a-3c show steps included in a process of using a flexible mold to form the partitions in a plasma display panel. According to this process, a curable resin 41 is coated on the top surface of a basic mold 40, where the top surface is formed with partition shapes. The partition shapes are then filled with the curable resin coated on the top surface of the basic mold by a squeezer 45. The squeezer moves from one end of the mold to the other end to fill the partition shapes with the curable resin. A light-curable resin may be used because a light-curable resin can be cured within a short period of time.

If all the partition shapes are filled with the curable resin, a flexible film 47 is aligned on the top of the mold. Once the flexible film has been aligned aligned, a press roll 49 is moved across the top of the flexible film.

Then, as shown in FIG. 3c, a curing step is performed by exposing the flexible film (pressed against the curable resin) to UV light or the like. After a predetermined length of time has passed, a finished flexible mold 50 is separated from the basic mold. The flexible mold is formed with inverted-partition shapes as shown in FIG. 3e.

Like the metallic mold process, a partition source material is coated on flexible mold 50 and press-molded on the top surface of a glass. Then, the flexible mold is wound upward to release from the glass, thereby fabricating the bottom panel 20.

However, the aforementioned methods of molding partitions on a display panel have a number of problems. For example, in the metallic mold process, there is an advantage in that the process is simple and the coefficient of utilization for source material is high. However, the partitions molded through this method lack evenness of height. Moreover, bottom glass 30 may be fractured by pressure applied from metallic mold 33.

In addition, after press-molding, it is difficult to separate metallic mold 33 and partition source material 31 from one another. Therefore, when the metallic mold is separated from bottom glass 30, partition source material 31 may be partially torn out as shown in FIG. 2c.

In the flexible mold process, there is an advantage in that the process is simple compared with the metallic mold process. Also, the glass substrate is not likely to fracture at the time of press-molding because flexible mold 50 is used. However, because the flexible mold is formed from a curable resin, the mold lacks endurance and is subject to dimensional variation when repeatedly used. In addition, the thermal expansion rate of the flexible mold tends to change based on environment conditions. As a result, flaws may be formed in the resulting panel because the basic mold and curable resin may be different from each other in terms of their thermal expansion rates.

All of the effects may cause the partitions of flexible mold to not be uniform such as shown, for example, in FIG. 3e. These effects may deteriorate the dimensional evenness of the walls forming the pixel or sub-pixel cells in the panel, which in turn deteriorate the evenness of discharge spaces of the PDP, thereby causing poor light emission.

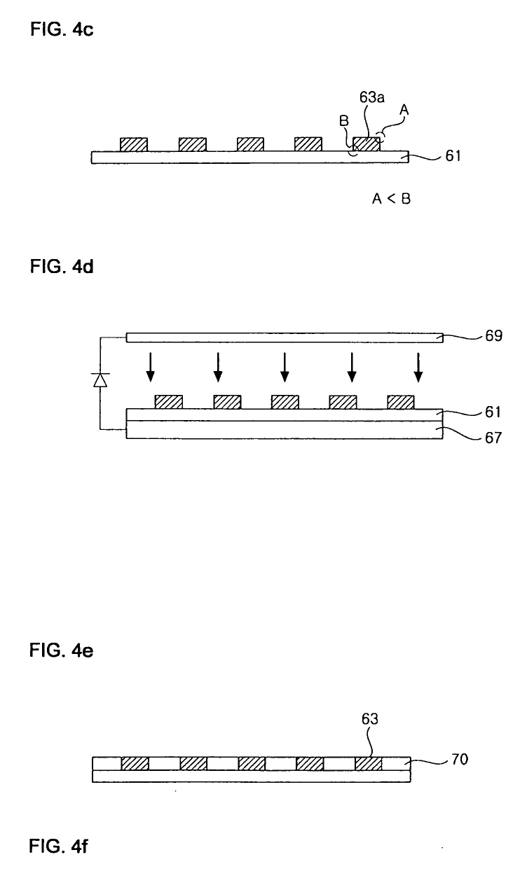

FIGS. 4a-4f show steps included in another method which uses a flexible mold to form partitions (e.g., pixel or sub-pixel walls) in plasma display panels. In FIG. 4a, a flexible film 61 which serves as a support for a flexible mold is aligned on a surface plate 60. Because light penetration may be employed in the process of practically molding partitions (to be described in greater detail below), flexible film 61 may be formed from an optically transparent material. In alternative embodiments, film 61 may be formed from another material.

After the flexible film has been aligned, partition shapes corresponding to partitions to be molded are formed using a photosensitive layer 63 coated on a top surface of flexible film 61. In order to form the partition shapes, photosensitive layer 63 is formed as a layer, with one or more predetermined sections of the layer then being selectively removed through exposure or heat treatment. By selectively removing predetermined sections of the photosensitive layer, patterns that substantially correspond to partitions on the panel can be formed.

Photosensitive layer 63 may be formed using, for example, a photosensitive resin or a photoresist film. The photosensitive resin may be prepared in liquid phase and coated to a thickness which corresponds to a height of the layer of plated patterns to be formed on the top surface of the flexible film. If the height of the plated patterns (herein, the plated patterns may be referred to as inverted-partition shapes) is approximately 100 to 250 μm, photosensitive layer 63 formed from the photosensitive resin may be coated to a thickness which lies, for example, in the range of 100 to 250 μm. Of course different thicknesses may be used in other embodiments.

The photosensitive layer may alternatively be formed from a photoresist film. Of course, it is also possible to selectively remove one or more desired sections of the photoresist film through exposure or heat treatment. The photoresist film may have a thickness that corresponds to a height of the layer of inverted-partition patterns to be formed on the top surface of flexible film 61. The photoresist film may cover one end of the flexible film to the other end. The photosensitive layer formed on the top surface of the flexible film so that the area of the former corresponds to that of the latter.

After the photosensitive layer has been formed, a curing step is performed. The curing step is performed for a predetermined length of time at a predetermined temperature. With a liquid photosensitive resin, the curing step is preferably performed within ten minutes at a temperature of about 120°. With a photoresist film, the curing step may be performed for ten minutes or less at a temperature of about 80°. As a result of the curing step, the photosensitive layer 63 and flexible film 61 can be rigidly bonded together.

After the photosensitive layer has been formed, a process of forming partitions 63a using the photosensitive layer is performed. This process may include an exposure mask aligning step, an exposing step, a developing step, a cleaning step, and a drying step. The exposure mask aligning step may involve aligning an exposure mask 65 formed with partition shapes on the top surface of flexible film 61 formed with the photosensitive layer 63 as shown in FIG. 4b.

The exposing step may include exposing the upper side of the aligned exposure mask 65 using ultra violet rays or the like. In the exposing step, an exposure light source with a predetermined level of energy may be employed and the exposure is performed for a predetermined length of time. Also, in the exposing step, one or more portions selected by the exposure mask are exposed to the light source.

As a result of the exposing step, photosensitive layer 63 coated on flexible film 61 is divided into exposed and non-exposed parts. It is possible to selectively remove the exposed or non-exposed parts depending on the type of the photoresist employed as the photosensitive layer.

When the exposing step has been completed, a developing step is performed. In the developing step, exposed parts or non-exposed parts are selectively removed using, for example, an alkali solution diluted to a predetermined concentration. Once the developing step is completed, a cleaning step using, for example, distilled water is performed and then a drying step is performed for drying the flexible film for a predetermined period of time at a predetermined temperature.

Through the above-mentioned steps, partitions 63a are formed on the top surface of flexible film 61 as shown in FIG. 4c. The partitions 63a will have a shape substantially similar to the partitions of a flat display panel.

Here, top corners A and bottom corners B of each partition 63a may be rounded so that each of corner has a predetermined radius of curvature. The predetermined radii of curvature of the top and bottom corners will be used to define the shapes and radii of curvature (Rt, Rb) of the corners of inverted-partition plated patterns on the finally completed flexible mold, as shown in FIG. 4f. Because the top and bottom corners of the cavities on the flexible mold are rounded in this manner, it is naturally possible to minimize the rejected rate of products at the time of molding the partitions included in a flat display panel formed by the flexible mold, and to thereby enhance image quality displayed on such a flat display panel.

In order to form top corners A and bottom corners B of partitions 63a to have a predetermined radius of curvature, various factors may be taken into consideration such as the material and sensitivity of the photoresist layer, the intensity and direction of light from a light source, and the repeated number of times the photoresist is cleaned with a developer.

Preferably, the radius of curvature of the top corners A is smaller than that of bottom corners B. If the radius of curvature of top corners A is smaller than that of bottom corners B, then the radius of curvature of the bottom corners of the partitions of the flat display panel, to be molded by the flexible mold, will be different than that of the top corners of the partitions. In one embodiment, the radii of curvature of the top and bottom corners A and B may be formed to cause the radius of curvature of the bottom corners of the partitions of the flat display panel to be greater than the top corners. In an alternative embodiment, the radii of curvature of the top and bottom corners A and B may formed to cause the radius of curvature of the bottom corners of the partitions of the flat display panel to be less than the top corners. If the radius of curvature of the bottom corners of the partitions of the flat display panel is different from that of the top corners, when each cell is discharged, phosphors coated between the partitions are excited by ultra-violet rays, thereby providing a more efficient emission of visible rays.

Preferably, each partition 63a formed during the etching step has a substantially trapezoidal shape rather than a rectangular shape. That is, it is preferable that each partition 63a has a trapezoidal shape, the top side of which is relatively longer than its bottom side (the side in contact with the flexible film). The difference in length between the top and bottom sides is preferably determined in such a manner that the opposite side walls of each partition has an angle of, for example, about 6 degrees or slightly larger than 6 degrees in relation to a vertical plane. In alternative embodiments, the trapezoidal-shaped partitions 63a may have top side which is shorter than its bottom side.

If each partition 63a has a trapezoidal shape, each plated pattern 70 shown in FIG. 4f will also be produced with a trapezoidal shape, the top side of which is relatively longer (or alternatively shorter) than its bottom side. Consequently, each partition of the flat display panel to be formed using flexible mold 71 will have a trapezoidal shape, the top side of which is longer (or alternatively shorter) than the bottom side thereof.

Each partition 63a may be formed to have a trapezoidal shape using various methods. For example, it is possible to form the trapezoidal shape of each partition 63a by repeatedly performing the steps of forming, exposing and developing the photosensitive layer. Alternatively, it is possible to obtain trapezoidal-shaped partitions 63a by adjusting the intensity and direction of exposing light and the material (sensitivity) of the photoresist.

Through the above-mentioned process, partitions 63a are formed on the top surface of flexible film 61, where partitions 63a may be considered as patterns that substantially corresponding to the partitions (e.g., pixel or sub-pixel walls) of a flat display panel.

Next, on the top surface of flexible film 61 between partitions 63a, a process of forming a layer of patterns is performed, for example, through plating. As shown in FIG. 4d, this may be accomplished by positioning flexible film 61 with partitions 63a on the top surface of a support plate 67. The support plate may have dimensions that correspond to the entire area of the flexible film 61 or different dimensions may be used.

Then, flexible film 61 (supported by the support plate 67) is moved to a plating chamber (not shown). Electroplating is then performed in the chamber (not shown) to form a dry-plated layer on the top surface of the flexible film. At this time, a layer of metallic plated patterns 70, each corresponding to an inverted-partition shape of partitions to be included in the flat display panel, may be formed to a predetermined thickness.

Electroplating may be performed, for example, by positioning a plating plate 69 in opposing relation to flexible film 61 at a predetermined distance from the flexible film and then applying a predetermined voltage between the plating plate and support plate. A layer of plated patterns 70 is thereby formed on the top surface of the flexible film at positions which correspond to either the exposed parts or non-exposed parts removed in the developing step. That is, plated patterns 70 are formed on the top surface of the flexible film between partitions 61, as shown in FIG. 4e.

Alternatively, electroplating may be performed through chemical evaporation, reaction, decomposition, etc. of a material to be deposited, and/or where evaporation is performed within a vacuum environment so that the evaporated material is deposited and solidified on a base material. Any of the aforementioned methods may be employed. In addition, electroplating may be employed by or in combination with an electroless plating method using reduction or replacement reaction.

The layer of plated patterns 70 may be fabricated from a material formed, for example, by compositely mixing ITO, Ni, Cr, Ag, Au, Pt, Cu, etc. The main metallic component of the layer of plated patterns may be Ni and the other metals are added by a predetermined ratio. In alternative embodiments, a different metal or material may be the main component.

Preferably, the layer of the plated patterns is formed to a height which, for example, is about 10 μm higher than that of the partitions to be molded on a glass. If a resin is used as the source material for the partitions, in the process of molding partitions using flexible mold 71 formed with plated patterns 70, the resin may contract. In this regard, the plated pattern layer may be formed, for example, to about 10 μm higher than that of the partitions to be molded on a glass.

When the step of forming the plated pattern layer is completed, partitions 63a and plated pattern layer 70 remain on the top surface of the flexible film. Next, a step of removing partitions 63a from flexible film 61 is performed.

This may involve, for example, moving flexible film 61 to a releasing bath (not shown). A step of releasing partitions 63a from the flexible film is then performed. In the photosensitive layer removing step, partitions 63a formed on the top surface of the flexible film are preferably removed using an etchant. The partitions are exposed parts or non-exposed parts which are crystallized during the exposing step, and a commercially available solution may be employed as the etchant. After using the etchant, a cleaning step may be performed for removing any etchant remaining on the surface. The cleaning step may be performed, for example, using distilled water. Then, a drying step may be performed for the flexible film for a predetermined length of time within a predetermined temperature range.

When the photoresist removing step is completed, the partitions 63a formed from the photosensitive layer are removed. As a result, formation of flexible mold 71 which includes flexible film 61 and plated patterns 70 is completed as shown in FIG. 4f Here, each of the plated patterns 70 is formed in a substantially inverted-partition shape, e.g., an inverted shape which corresponds to the partitions to be formed in the PDP.

As can be seen from the enlarged view in FIG. 4f, plated patterns 70 may be repeatedly formed. Each plated pattern may have a cross-section of a trapezoidal shape, where according to one embodiment a top side of the trapezoidal shape is relatively shorter compared to the bottom side thereof and where the inverted-partition shape corresponds to an inverted shape for each of the partitions to be molded on a flat display panel. In each of the plated patterns 70, the top corners have a relatively large radius of curvature Rt as compared with the radius of curvature Rb of the bottom corners. In alternative embodiments, the opposite may be true. That is, the top side of the trapezoidal-shaped plated patterns may be longer than the bottom side and Rt may be less than Rb.

Here, the radius of curvature Rb of the bottom corners are determined by the radius of curvature of the bottom corners B of the above-mentioned partitions 63a, and the radius of curvature Rt of the top corners are determined in the above-mentioned plating process. Using the radius of curvature Rb of the bottom corners B of partitions 63a, it is possible to form each of the plated patterns 70 in a trapezoidal shape in such a manner that, for example, the radius of curvature Rt of the top corners of the trapezoid shape is larger than the radius of curvature Rb of the bottom corners thereof. In alternative embodiments, the opposite may be true.

As described above, by rounding the top and bottom corners of trapezoidal shapes of plated patterns 70, each of which is formed in an inverted shape for the partitions to be molded on a flat display panel, it is possible to prevent defects and inconsistencies from occurring, e.g., having the partitions partially torn out when fabricating a flat display panel. In addition, it is also possible to fabricate partitions that render images that will be well displayed in terms of light emission quality.

Furthermore, by forming plated patterns 70 so that the top corners of each of the plated patterns 70 have a relatively large radius of curvature Rt compared to the radius of curvature Rb of the bottom corners, it is possible to mold the partitions on a flat display panel so that the radius of curvature of the bottom corners of the partitions is defined to be relatively large compared to that of the top corners thereof. As the radius of curvature of the partitions of the flat display panel is defined to be relatively large, phosphors coated between the partitions are excited by ultra-violet rays when individual cells discharge, thereby more efficiently emitting visible rays, as described above.

It can be appreciated that flexible mold 71 employs a flexible film as a base, on the top surface of which a layer of plated patterns 70, each corresponding to an inverted-partition shape of the PDP partitions. Because plated patterns 70 are formed from a metallic material, it is not subject to contraction due to curing. In addition, it has a superior characteristic against changes of dimensions and wearing caused by repeated use.

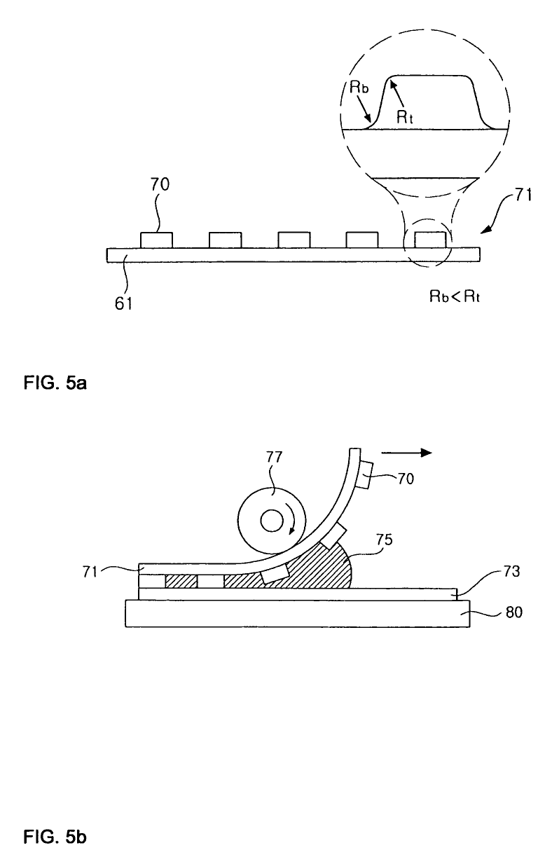

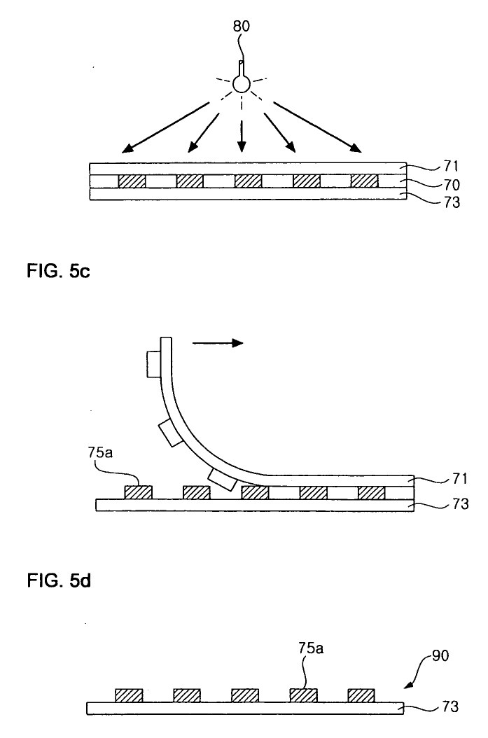

FIGS. 5a-5d show steps included in a process for molding partitions using the flexible mold formed by the process of FIGS. 4a-4f. As shown FIG. 5a, a glass to be formed with partitions is seated on a surface plate 80 with a top flat surface. The surface plate 80 may already have been formed with electrodes (not shown).

Next, one end of the flexible mold 71 is anchored to the surface plate 60 and the other end is moved by a separate device, so that the top surface of glass 73 is covered by the flexible mold from one end to the other end. At this time, a source material 75 for forming the partitions is interposed between glass 73 and flexible mold 71. The source material may be formed from a resin (for example, light-curable resin). While the flexible mold is covering the glass, a press roll 77 moves in an advancement direction on the top surface of the flexible mold, thereby pressing the flexible mold against the glass.

Next, as shown in FIG. 5b, a heat-curing or light-curing process is performed by using a heat source or light source 80 having a level of energy located above the flexible mold. Through the heat-curing or light-curing process, the source material 75 for partitions is cured. Because the flexible film is formed from an optically transparent material, the source material can be cured.

If the source material is a resin, it contracts while being cured. However, because the layer of the plated patterns 70 on the flexible mold may be formed to be higher (e.g., by about 10 μm) than the height of the partitions to be molded, it is possible to obtain a desired height of the partitions even if the source material contracts.

When curing of source material 75 is completed, one end of the flexible mold is wound up to separate the flexible mold from glass 73. A predetermined treatment may be performed on the top surface of glass 75 after the flexible mold is separated from glass 73.

By the above-mentioned process, partition shapes 75a are formed on the bottom panel 90 of a flat display panel. The height of the partition shapes may be, for example, about 100 to 250 μm. When pressure is applied to the opposite ends of the bottom panel, the bending curvature of the bottom panel is preferably not more than a predetermined amount (e.g., 1000 mm) in terms of radius of curvature.

As described above, a flexible mold is therefore formed with a layer of plated patterns, each having inverted-partition shape. The patterns may be formed of a metallic or other material deposited on a flexible film of a soft material. If made from metal, patterns may be formed through plating.

Moreover, since the plated patterns on the flexible mold are formed of a plated pattern layer, dimensional unevenness is not caused by differences in heat expansion coefficient. As a result, dimensional evenness can be improved. Furthermore, since such a plated pattern layer has superior endurance compared to ordinary curable resin, dimensional variation can be prevented even if such a flexible mold is repeatedly used.

In accordance with one embodiment, there is provided a method of fabricating a flexible mold for molding partitions of a flat display panel including: a first step for forming patterns corresponding to the partitions on an optically transparent flexible film; a second step for forming, on the flexible film, a plated pattern layer, each corresponding to an inverted-partition shape between the patterns; and a third step for removing the patterns.

The patterns in the first step may be formed of a photosensitive layer. Here, the step of forming the patterns corresponding to the partitions with the photosensitive layer preferably includes steps of: forming a photosensitive layer in predetermined thickness on the top surface of the flexible film; selectively exposing the photosensitive layer using a exposure mask; and developing the selected and exposed parts of the photosensitive layer using an etchant so as to remove the exposed parts.

The method may further include steps of: cleaning the etchant remaining on the top surface of the flexible film after the developing step; and drying the flexible film after the cleaning step. In addition, the patterns in the first step are preferably molded in such a manner that each of top and bottom corners thereof has a predetermined radius of curvature. Preferably, the cross-section of each of the patterns in the first step has a trapezoid shape, the top side of which is relatively long as compared to the bottom side.

Preferably, the plated patterns in the second step are molded in such a manner that each of the top and bottom corners thereof has a predetermined radius of curvature. In addition, the cross-section of each of the plated patterns preferably has a trapezoid shape, the top side of which is relatively long as compared to the bottom side thereof. Here, the radius of curvature of the top corners is also preferably larger than that of the bottom corners.

According to another embodiment, there is also provided a flexible mold for molding partitions on a flat display panel including: a flexible film of an optically transparent material; and a layer of plated patterns formed on the top surface of the flexible film from a metallic material through plating, wherein each of the plated patterns has an inverted-partition shape.

Each of the top and bottom corners of the plated patterns preferably has a predetermined radius of curvature. The cross-section of each of the plated patterns may have a trapezoid shape, the top side of which is relatively longer than the bottom side thereof. More preferably, the radius of the top corners of each of the plated patterns is relatively larger than that of the bottom corners.

According to the flexible mold with the above-mentioned technical features and method of fabricating the same, the flexible mold can be fabricated in a more precise dimension and the dimensional variation of the flexible mold caused by repeated use can be prevented.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method of fabricating a mold for forming a flat display panel, comprising:
forming a plurality of protrusions on a flexible film;
forming plated patterns between the protrusions on the flexible film, the plated patterns having an inverted shape that corresponds to partitions that define one or more pixel or sub-pixel regions in the panel; and
removing the protrusions to form a flexible mold.

2. The method of claim 1, wherein the protrusions are made of a photosensitive material.

3. The method of claim 2, wherein the plurality of protrusions are formed by:
forming a photosensitive layer of predetermined thickness on the flexible film;
selectively exposing the photosensitive layer using an exposure mask; and
developing the exposed or non-exposed portions of the photosensitive layer to remove said portions.

4. The method of claim 3, further comprising:
cleaning remaining etchant on the flexible film after said developing; and
drying the flexible film after cleaning.

5. The method of claim 1, wherein each of the protrusions has top and bottom corners and wherein the top and bottom corners are formed to have predetermined radii of curvature.

6. The method of claim 5, wherein the radius of curvature of the top corners is different from the bottom corners.

7. The method of claim 6, wherein a cross-section of each protrusion has a trapezoidal shape, a top side of which is different from bottom side thereof.

8. The method of claim 7, wherein each of the plated patterns has top and bottom corners which have predetermined radii of curvature.

9. The method of claim 8, wherein a cross-section of each plated pattern has a trapezoidal shape, a top side of which is different from a bottom side thereof.

10. The method of claim 8, wherein each of the plated patterns is formed so that a radius of curvature of the top corners is different from that of the bottom corners.

11. The method of claim 8, wherein a height of the plated patterns is larger than the partitions that define one or more pixel or sub-pixel regions in the panel.

12. The method of claim 1, wherein the flexible film is made of an optically transparent material.

13. A flexible mold for making a flat display panel, comprising:
a flexible film; and
a plurality of patterns on the flexible film, wherein the patterns are made of a metal and have an inverted shape that corresponds to partitions defining one or more pixel or sub-pixel regions in the panel.

14. The flexible mold of claim 13, wherein top and bottom corners of the plated patterns have predetermined radii of curvature.

15. The flexible mold of claim 14, wherein a cross-section of each of the plated patterns is a trapezoidal shape, a top side of which is different than a bottom side thereof.

16. The flexible mold of claim 15, wherein a radius of curvature of the top corners of each plated pattern is different than that of the bottom corners.

17. The flexible mold of claim 14, wherein a height of the plated patterns is larger than that of the partitions forming the one or more sub-pixel regions in the panel.

18. A method of making a plasma display panel, comprising:
forming a plurality of walls that define one or more pixel or sub-pixel regions in the panel, said forming including:
providing a mold having a plurality of patterns on a flexible film, each of said patterns having one or more curved corners and an inverted shape that corresponds to one of the walls that define one or more of the pixel or sub-pixel regions,
placing a source material on the substrate; and
applying the mold over the source material to form the walls of the panel.

19. The method of claim 18, wherein each pattern has top and bottom corners that are curved.

20. The method of claim 19, wherein a radius of curvature of the top corners is different from a radius of curvature of the bottom corners.

21. The method of claim 18, wherein each pattern has a trapezoidal cross-sectional shape.

22. The method of claim 21, wherein a top side of each trapezoidal-shaped pattern is different in length from a bottom side.

23. The method of claim 18, wherein the substrate corresponds to a bottom glass of the panel.

24. The method of claim 18, wherein the flexible film is formed from a transparent material.

25. The method of claim 18, wherein each pattern is made from a metal.
